(19) United States
(12) Patent Application Publication
(10) Pub. No.: US 2006/0027036 A1
(43) Pub. Date: Feb. 9, 2006

(54) Methods and apparatuses for imprinting substrates

(76) Inventors: Todd L. Biggs, Queen Creek, AZ (US); Jeff R. Wienrich, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/913,903

(22) Filed: Aug. 5, 2004

(51) Int. Cl. H01Q 3/08

(52) U.S. Cl. 74/1 R

(57) ABSTRACT

A method and apparatus for imprinting substrates. One embodiment of the invention provides a microtool having a sidewall on one or both plates. The sidewalls help prevent excess dielectric material from forming on the microtool plates or the substrate. For one embodiment of the invention, each microtool plate has a sidewall formed thereon. Upon application of pressure, the sidewalls contact each other, thus reducing or eliminating flexing of the microtool plates.

### FIELD

Embodiments of the invention relate generally to the field of microelectronic device fabrication and more specifically to methods and apparatuses for imprinting substrates to fabricate such devices.

### BACKGROUND

One of the processes of fabricating a microelectronic device is imprinting a substrate. Imprinting is a new process for making substrates. Typically, a substrate core, which may be a metal or an organic compound, has a layer of dielectric material disposed on one or both sides. The dielectric material may be comprised of a thermal setting epoxy. The dielectric layer may be applied as a flat sheet of thermal setting epoxy that is then imprinted to form traces. The traces are then plated with a conductive material (e.g., copper) to form electrically conductive traces for the microelectronic device circuits. Subsequent layers and associated electronic circuitry are formed to complete the device.

Typically, the thermal setting epoxy layer is imprinted with an imprinting microtool. The conventional design of such microtools has many distinct disadvantages illustrated by FIGS. 1A-1C.

FIG. 1A illustrates a microtool in accordance with the prior art. The microtool plates 105 are typically a thin metal (e.g., a 30 mil nickel plate) with raised and recessed portions 106 and 107, respectively. The raised and recessed portions of the microtool are known as features and are typically about 50-70 microns from top to bottom. Each plate of the microtool is held in place by a vacuum or other means (not shown) and pressed into the thermal setting epoxy layers 110 disposed on the substrate core 115. The epoxy layers are typically about 40 microns. Upon application of heat and pressure, the recessed portions are filled with epoxy and the raised portions displace epoxy. One disadvantage of such a scheme is that the epoxy material is not contained; that is, there is nothing to prevent or restrict the flow of the epoxy in an undesired manner. When heat and pressure are applied to the microtool plates, the epoxy material is allowed to flow out. A slight tilt in the apparatus could cause the epoxy to flow in undesired amounts and locations. The wetting properties of the epoxy material cause excess material to accumulate along the edge of the microtool plate, that is, the overflowing epoxy may build up around the edge of the plate causing a malformation of the desired features.

Also, because the microtool is comprised of thin plates, when under pressure the plates flex particularly along the outer edges where there is less epoxy material to provide resistance. This inward flexing along the edges causes non-uniformity in the thickness of the epoxy layer. This causes the epoxy layer to be thinner than desired near the edges.

FIG. 1B illustrates an epoxy layer formed using a microtool in accordance with the prior art. As shown in FIG. 1B, features 111 near the edge of epoxy layer 110 are malformed due to the flexing of the microtool plate. The flexing may be so pervasive as to create a “dimple” 112 in substrate core 115. Additionally, the raised portions 106 act as a standoff for the microtool and can therefore dimple substrate core 115.

This problem has been addressed with limited success by trying to gauge the amount of material so as to limit overflow. This has not proven very effective; when an insufficient amount of epoxy is used, the result is a defective part as described above. When an excessive amount of epoxy is used, the excess 125 forms along the edge of the plate 105 (FIG. 1D), thus causing a subsequent substrate planarization process to take longer. Additionally, the excess material is not uniform and therefore makes it difficult to hold a vacuum or maintain mechanical tool attachment during subsequent processes. Moreover, the excess material causes the substrate to stick to the microtool plate. Removing the substrate (e.g., prying it from the plate) can damage the plate and/or substrate.

Over time, the repeated flexing of the microtool plates along the edges can cause the edges to become permanently deformed. Such deformation leads to defective substrate features and makes it difficult to maintain a vacuum or mechanical attachment on the plate.

FIG. 1C illustrates the deformation of a microtool plate in accordance with the prior art. As shown in FIG. 1C, plate 105 is deformed at edges 120. This deformation is due to repeated flexing of the plate, while imprinting an epoxy layer in which the epoxy has flowed in undesired amounts or locations.

### BRIEF DESCRIPTION OF THE DRAWINGS

The invention may be best understood by referring to the following description and accompanying drawings that are used to illustrate embodiments of the invention. In the drawings:

FIG. 1A illustrates a microtool in accordance with the prior art;

FIG. 1B illustrates an epoxy layer formed using a microtool in accordance with the prior art;

FIG. 1C illustrates the deformation of a microtool plate in accordance with the prior art;

FIG. 1D illustrates excess material flow around plate perimeter;

FIG. 2 illustrates a microtool in accordance with one embodiment of the invention;

FIG. 2A illustrates a microtool in which one of two plates has a sidewall in accordance with one embodiment of the invention;

FIG. 3 illustrates a microtool having plates with sidewalls formed to contact the substrate core in accordance with one embodiment of the invention;

FIG. 4 illustrates a microtool having one or more vent holes formed therein to increase the flow of the dielectric material throughout the reservoir formed by the sidewalls in accordance with one embodiment of the invention;

FIG. 4A is a top-down view of a microtool plate having vent channels formed therein in accordance with one embodiment of the invention; and

FIG. 5 illustrates a process in which a microtool is formed in accordance with one embodiment of the invention.

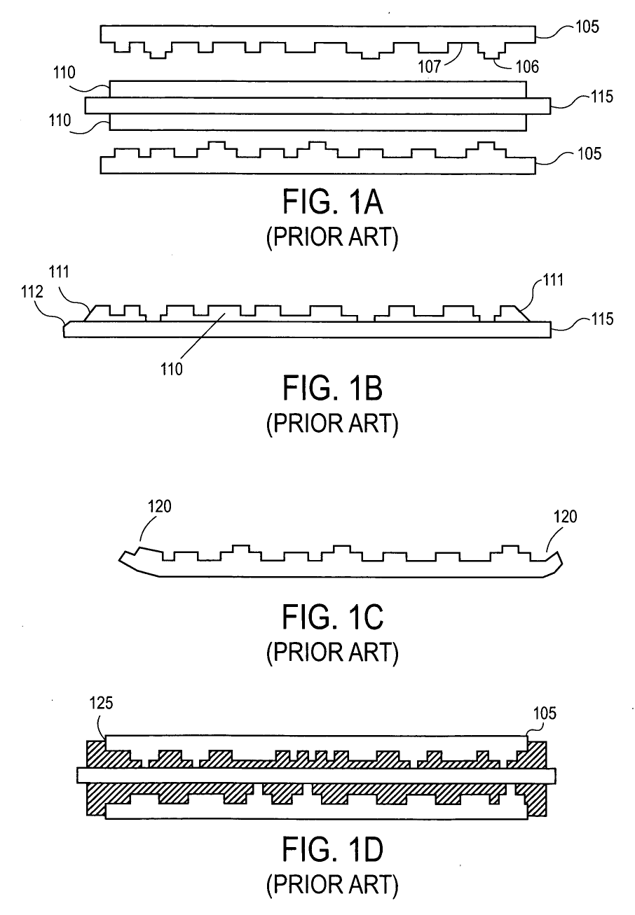

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

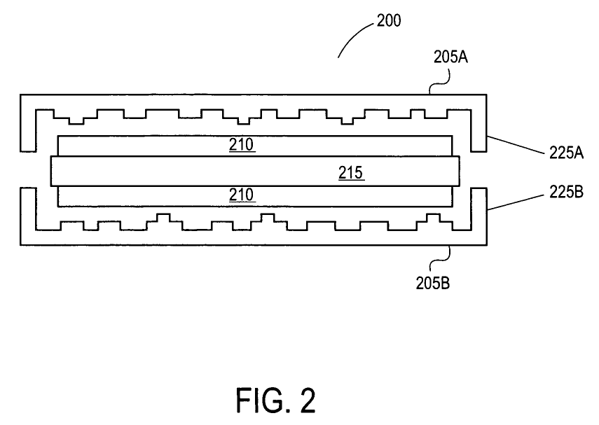

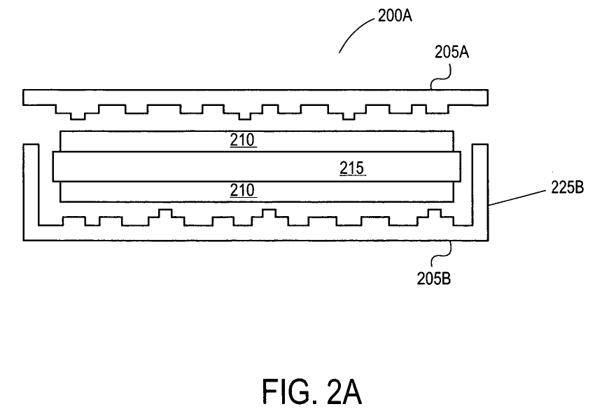

FIG. 2 illustrates a microtool in accordance with one embodiment of the invention. Microtool 200, shown in FIG. 2, includes sidewalls 225a and 225b on plates 205a and 205b, respectively. For one embodiment of the invention, the sidewalls are integrally formed with the plates and made of the same material as the plates, which is for one embodiment nickel or a nickel alloy, but may be other materials, metal or non-metal, for the same purpose. The sidewalls form a reservoir around the imprint pattern (i.e., the features) of the microtool plates. The dimensions of sidewalls 225a and 225b are set to accommodate the thickness of substrate core 215 such that upon pressure being applied to the plates, the imprint pattern extends a desired amount into dielectric layers 210. The dielectric layers 210 may be comprised of thermal setting epoxy, thermoplastic or other suitable material. For one embodiment of the invention, each of the sidewalls 225a and 225b extend beyond the imprint pattern; a distance equal to approximately one half of the thickness of the substrate core 215.

Upon heat and pressure being applied to the plates 205a and 205b, the sidewalls 225a and 225b contact each other. Because the sidewalls provide resistance one against the other, the amount of pressure applied is not as critical as in prior art schemes. For typically employed pressures, the edge of each plate will not flex due to the resistance created between sidewalls 225a and 225b. Additionally, in a closed or imprinting position, microtool 200 envelopes the entire substrate, thus the dielectric material cannot accumulate on the edge of the microtool plates nor can excess dielectric material form along the edge of the substrate. Moreover, tilting will not cause defective parts, as the dielectric material cannot flow as readily to undesired locations.

For one embodiment of the invention, the sidewalls of the microtool are positioned such that upon imprinting, the entire substrate is encapsulated within the dielectric material. Such an embodiment will result in reduction or elimination of the substrate sticking to the microtool.

Various alternative embodiments of the invention reduce or eliminate flexing of the microtool plates along the edges, flow of the dielectric material to undesired locations due to tilt, and accumulation of excess dielectric material along the edges of the substrate, thus providing an imprinted substrate having a total thickness variation (TTV) of approximately 7 microns.

In an alternative embodiment, only one of the microtool plates may include a sidewall. FIG. 2A illustrates a microtool in which one of two plates has a sidewall in accordance with one embodiment of the invention. Microtool 200A shown in FIG. 2A, includes a sidewall 225 formed on the lower plate 205b. Plate 205a does not include a sidewall. For such an embodiment, the height of sidewall 225 is based upon the substrate core 215 such that upon pressure being applied to the plates, the imprint pattern extends a desired amount into the dielectric layers 210.

As described above in reference to FIG. 2, the microtool in accordance with one embodiment of the invention has sidewalls that contact each other during the imprinting process. For such an embodiment, the height of the sidewalls is determined within strict tolerances to ensure that the sidewalls do not prevent the imprint pattern from properly contacting the dielectric layer.

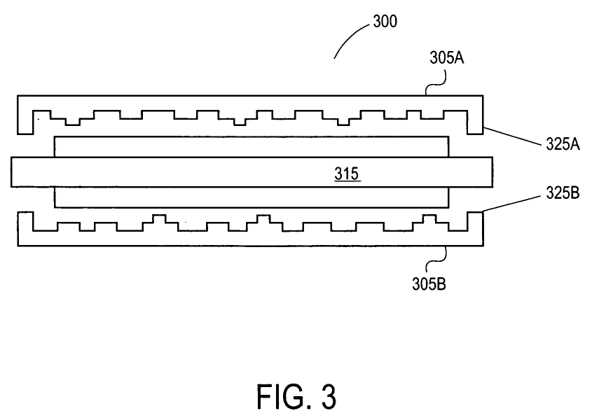

FIG. 3 illustrates a microtool having plates with sidewalls formed to contact the substrate core in accordance with one embodiment of the invention. Microtool 300, shown in FIG. 3, includes sidewalls 325a and 325b on plates 305a and 305b, respectively. As shown in FIG. 3, upon applying pressure to the plates, the sidewalls contact a substrate core 315. Each of the sidewalls 325a and 325b form a separate reservoir around the imprint pattern of each of the respective of the microtool plates, 305a and 305b.

For such an embodiment, it is no longer necessary to determine the height of the sidewalls based upon the thickness of the substrate core. Instead, the height of the sidewalls is approximately equal to the feature dimensions. Such an embodiment allows for ease of manufacturing. However, because the sidewalls will contact the substrate core, stricter tolerances on the applied pressure are observed to avoid dimpling the substrate core or damaging circuits with the substrate core.

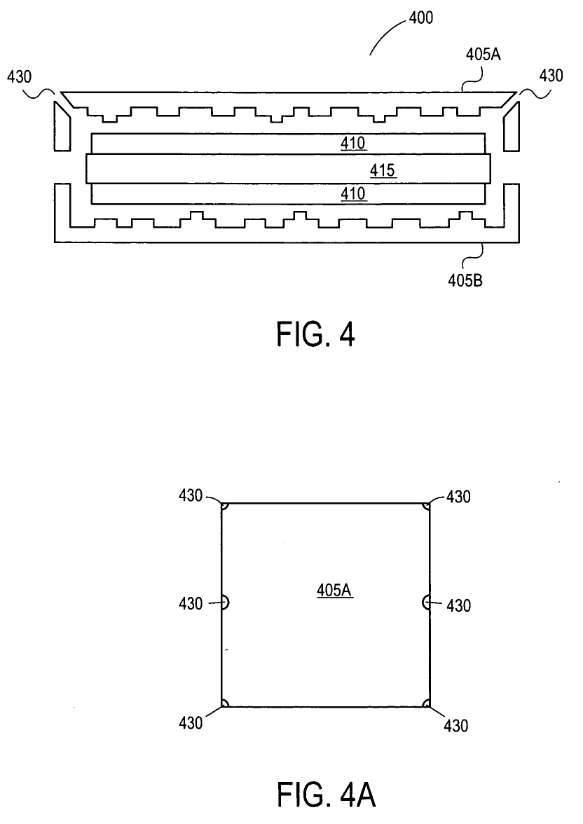

FIG. 4 illustrates a microtool having one or more vent channels formed therein to increase the flow of the dielectric material throughout the reservoir formed by the sidewalls in accordance with one embodiment of the invention. As shown in FIG. 4, microtool 400 has vent channels 430 formed in upper plate 405a. The vent channels may be formed at any location on the plate and may be formed additionally or alternatively on lower plate 405b. The dielectric material is less likely to flow into certain areas of the reservoir formed by the microtool plates. For example, the dielectric material is less likely to flow into the upper corners of the reservoir (i.e., the corners formed by the upper plate sidewalls). The vent channels help the dielectric material from the dielectric layer 410 to flow into such areas within the reservoir. Moreover, the vent channels allow excess dielectric material to escape from the reservoir without accumulating on the substrate or the microtool plates.

FIG. 4A is a top-down view of microtool plate 405a having vent channels 430 formed therein in accordance with one embodiment of the invention.

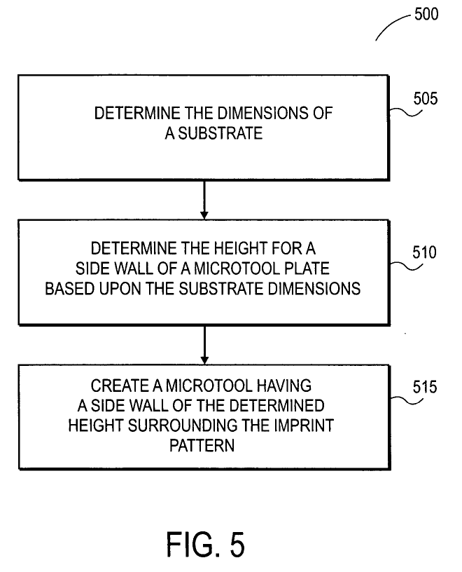

FIG. 5 illustrates a process in which a microtool is formed in accordance with one embodiment of the invention. Process 500, shown in FIG. 5, begins with operation 505 in which the dimensions of a substrate are determined. The dimensions may include the substrate core thickness as well as the dielectric layer thickness and the dimensions of the features to be imprinted on the substrate.

At operation 510, the height of a sidewall for a microtool plate is determined based upon the substrate dimensions. For example, for a microtool as described above in reference to FIG. 2, in which each sidewall will contact the sidewall of the opposing plate, the substrate core thickness as well as the feature dimensions are used to determine the sidewall height. For such an embodiment, the sidewall height for each plate is approximately equal to the feature height plus one half of the substrate core thickness. For a microtool as described in reference to FIG. 3, the sidewall height for each plate is approximately equal to the feature height.

At operation 515, a microtool is formed having a sidewall of the determined height on at least one plate surrounding the imprint pattern. Additionally, one or both plates of the microtool may have vent channels formed therein to aid the flow of the dielectric material as discussed above in reference to FIGS. 4 and 4A.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
one or more plates, each plate having a corresponding imprint pattern formed thereon; and
one or more sidewalls, each sidewall surrounding the corresponding imprint pattern of a respective plate.

2. The apparatus of claim 1 wherein each sidewall is integrally formed with the respective plate.

3. The apparatus of claim 1 wherein each plate is a metal plate approximately 30 mils thick, the metal selected from the group consisting essentially of nickel and nickel alloy.

4. The apparatus of claim 1 wherein at least one of the plates has one or more vent channels formed therein.

5. A microtool comprising:
an upper plate having a first imprint pattern formed thereon, the upper plate having a first sidewall surrounding the first imprint pattern; and
a lower plate having a second imprint pattern formed thereon, the lower plate having a second sidewall surrounding the second imprint pattern.

6. The microtool of claim 5 wherein upon application of pressure the first sidewall contacts the second sidewall such that the first sidewall helps reduce a flexing of the lower plate and the second sidewall helps reduce a flexing of the upper plate.

7. The microtool of claim 6 wherein the first sidewall in contact with the second sidewall forms a reservoir for a dielectric material of a substrate such that an accumulation of an excess of the dielectric material on the substrate, the upper plate, and the lower plate is reduced.

8. The microtool of claim 6 wherein the height of the first sidewall and the second sidewall is determined based upon the thickness of a substrate core of a substrate to be imprinted.

9. The microtool of claim 5 wherein each of the upper plate and the lower plate is a metal plate approximately 30 mils thick, the metal selected from the group consisting essentially of nickel and nickel alloy.

10. The microtool of claim 5 wherein upon application of pressure the first sidewall contacts an upper surface of a substrate core and the second sidewall contacts a lower surface of the substrate core such that the substrate core helps reduce a flexing of the lower plate and a flexing of the upper plate.

11. The microtool of claim 10 wherein the first sidewall in contact with the upper surface of the substrate core forms a reservoir for a dielectric material of the substrate such that an accumulation of an excess of the dielectric material on the substrate and the upper plate is reduced, and the second sidewall in contact with the lower surface of the substrate core forms a reservoir for the dielectric material of the substrate such that an accumulation of an excess of the dielectric material on the substrate and the lower plate is reduced.

12. The microtool of claim 5 wherein at least one of the upper plate and the lower plate has one or more vent channels formed therein.

13. A microtool comprising:
a plate having a corresponding imprint pattern formed thereon, the imprint pattern surrounded by a sidewall formed on the plate; and
an opposing plate having a corresponding imprint pattern formed thereon.

14. The microtool of claim 13 wherein upon application of pressure the sidewall contacts a surface of the opposing plate such that the sidewall in contact with the surface of the opposing plate helps reduce a flexing of the plate and the opposing plate.

15. The microtool of claim 13 wherein the sidewall in contact with the surface of the opposing plate forms a reservoir for a dielectric material of a substrate such that an accumulation of an excess of the dielectric material on the substrate, the upper plate, and the lower plate is reduced.

16. The microtool of claim 15 wherein the plate has one or more vent channels formed therein.

17. A method comprising:
determining one or more dimensions of a substrate;
determining a height of a sidewall for a microtool plate based upon a dimension of the substrate; and
forming a microtool having one or more plates, each plate having a corresponding imprint pattern formed thereon, at least one of the plates having a sidewall, each sidewall surrounding the corresponding imprint pattern of a respective plate.

18. The method of claim 17 further comprising:
forming vent channels within one or more of the plates of the microtool.

19. The method of claim 17 wherein each sidewall is integrally formed with the respective plate.

20. The method of claim 17 wherein each plate is a metal plate approximately 30 mils thick, the metal selected from the group consisting essentially of nickel and nickel alloy.

21. The method of claim 17 further comprising:
forming a sidewall on each of two opposing plates of the microtool wherein upon application of pressure each sidewall contacts the sidewall of the opposing plate such that the sidewall of each plate helps to prevent flexing of the opposing plate.

22. The method of claim 21 wherein the sidewalls in contact with each other form a reservoir for a dielectric material of the substrate such that an accumulation of an excess of the dielectric material on the substrate and each of the two plates is reduced.

23. The method of claim 17 further comprising:
forming a sidewall on each of one or more corresponding plates of the microtool wherein upon application of pressure each sidewall contacts a core of the substrate such that the sidewall in contact with the substrate core helps to prevent flexing of the corresponding plate.

24. The method of claim 17 further comprising:
imprinting the substrate using the microtool.
